(19) United States
(12) Patent Application Publication
(10) Pub. No.: US 2008/0112668 A1
(43) Pub. Date: May 15, 2008

(54) Multiplexer-demultiplexer, receiver, transmitter, and manufacturing method

(75) Inventors: Koji Terada, Kawasaki (JP); Jun Matsui, Kawasaki (JP); Hiroyuki Nobuhara, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/896,305

(22) Filed: Aug. 30, 2007

(30) Foreign Application Priority Data
Nov. 13, 2006 (JP) 2006-306877

(51) Int. Cl. G02B 6/28; B32B 17/00

(52) U.S. Cl. 385/24; 156/99

(57) ABSTRACT

A multiplexer-demultiplexer includes a first lens, a multilayer filter, and a second lens. The first lens is positioned to collimate a multi-wavelength light having various wavelengths. The multilayer filter includes multiple filter films each arranged at a different angle, is positioned such that collimated multi-wavelength light enters and/or exits at an angle, separates the collimated multi-wavelength light into single-wavelength light according to wavelength, and reflects each of the single-wavelength light. The second lens is positioned to converge each of the single-wavelength lights separated by the multilayer filter at a different position.

### CROSS-REFERENCE TO RELATED APPLICATIONS

This application is based upon and claims the benefit of priority from the prior Japanese Patent Application No. 2006-306877, filed on Nov. 13, 2006, the entire contents of which are incorporated herein by reference.

### BACKGROUND OF THE INVENTION

1. Field of the Invention

The present invention relates to a multiplexer-demultiplexer, a receiver, a transmitter, and a manufacturing method for a multilayer filter.

2. Description of the Related Art

Recently, accompanying the spread of broadband for access networks, such as asymmetric digital subscriber lines (ADSL) and optical fibers, metro network traffic is increasing. To cope with this increase, technologies that realize high speed optical transmission, such as 40 giga bits per second (Gbps) or 100 Gbps, at a low cost are being investigated.

For example, applying cost reducing and spreading 10-Gbps transmission equipment technology, a method to achieve a 40-Gbps throughput by 10 Gbps×4 channel course wave division multiplexing (CWDM) waves is being researched. For CWDM, multiplexer-demultiplexers equipped with a multilayer filter have been presented, such as that disclosed in Japanese Patent Application Laid-Open Publication No. 2004-29243.

The multiplexer-demultiplexer disclosed includes a multilayer filter having an arrangement of layered filter films corresponding to different wavelengths. The multilayer is arrange such that collimated light enters the filter at an angle other than a right angle, thereby multiplexing and demultiplexing light according to wavelength.

However, in such conventional multiplexer-demultiplexers, a plurality of branched lights enter and exit the filter parallel to each other. Therefore, in order for respective branched lights to be converged at respective ports, a collimating lens for each branched light is required. As such, an increase in the quantity of wavelengths to be used increases the quantity of collimating lens required and the size of the multiplexer-demultiplexer.

Further, the more the collimating lens are provided, the more time and cost involved in arranging each lens are required. Particularly for metro networks, which require realization at a low cost, large module size and cost are huge problems.

### SUMMARY OF THE INVENTION

It is an object of the present invention to at least solve the above problems in the conventional technologies.

A multiplexer-demultiplexer according to one aspect of the present invention includes a first lens that collimates a multi-wavelength light having a plurality of different wavelengths; a filter unit that includes a plurality of filters, that is arranged such that the collimated multi-wavelength light enters at an angle other than a right angle, and that demultiplexes the multi-wavelength light into a plurality of lights each having a different wavelength so as to reflect the lights at different angles from each other, the filters arranged so as to have different angles from each other; and a second lens that converges each of the reflected lights to a different point corresponding to the different wavelength.

A multiplexer-demultiplexer according to another aspect of the present invention includes a first port through which a multi-wavelength light having a plurality of different wavelengths passes; a first lens that collimates the multi-wavelength light from the multi-wavelength light port; a filter unit that includes a plurality of filters, and through which the collimated multi-wavelength light enters at an angle other than a right angle, wherein the filters respectively correspond to the different wavelengths of the multi-wavelength light, each of the filters is configured to reflect a light having a wavelength corresponding thereto and to pass through a light having a wavelength other than the wavelength corresponding thereto, and the filters are arranged so as to have different angles from each other; a second lens that converges each of the reflected lights to a different point corresponding to the different wavelength; and a plurality of second ports that respectively correspond to the different wavelengths, and each of which is positioned at the different point so that the converged light having a wavelength corresponding thereto passes therethrough.

A receiver according to still another aspect of the present invention includes the multiplexer-demultiplexer according to claim 2. The ports are replaced by a plurality of light receiving elements that convert each of the single-wavelength lights output from the second lens into a plurality of electrical signals, and the multi-wavelength light port receives the multi-wavelength light from another communication apparatus and outputs, to the first lens, the multi-wavelength light.

A transmitter according to still another aspect of the present invention includes the multiplexer-demultiplexer according to claim 2. The ports are replaced by a plurality of light emitting devices that convert a plurality electrical signals into the single-wavelength lights and output the single-wavelength lights to the second lens, and the multi-wavelength light port outputs, to another communication apparatus, the multi-wavelength light incoming from the first lens.

A manufacturing method according to still another aspect of the present invention is for a filter having a plurality of filter films that are layered, and includes forming a filter on a surface of a substrate, the surface on which grooves are formed in a saw-tooth shape; applying a material having hardening and contracting properties on a surface of the filter; causing the material to harden and a contract; and creating a new filter on a surface of the hardened and contracted material. Steps of the applying the material on the surface of the filter, the causing the material to harden and contract, and the creating a new filter are repeated.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a multiplexer-demultiplexer according to an embodiment of the present invention;

FIG. 2 is a graph illustrating transmission characteristics of filters;

FIG. 3 is a schematic illustrating angles at which the filters reflect light;

FIG. 4 is a schematic of a multiplexer-demultiplexer according a modification of the embodiment;

FIG. 5 is a perspective view of a glass substrate for manufacturing a multilayer filter;

FIG. 6 is an enlarged cross-sectional view of a portion of the glass substrate;

FIG. 7 is an enlarged cross-sectional view of a portion of the glass substrate coated with polyimide;

FIG. 8 is an enlarged cross-sectional view of the portion of the glass substrate coated with polyimide that has hardened and contracted;

FIG. 9 is a cross-section of a multiplexer-demultiplexer according to a first example of the embodiment as viewed from a front aspect thereof;

FIG. 10 is a plan view of the multiplexer-demultiplexer according to the first example;

FIG. 11 is a cross-section of a multiplexer-demultiplexer according to a second example of the embodiment as viewed from a front aspect thereof;

FIG. 12 is a plan view of a multiplexer-demultiplexer according to the second example;

FIG. 13 is a cross section of a receiver according to a third example of the embodiment as viewed from a front aspect thereof;

FIG. 14 is a plan view of the receiver according to the third example;

FIG. 15 is an enlarged cross-sectional view of a portion of a glass substrate on which a filter film are formed by a manufacturing method according to an embodiment of the present invention as viewed from a side aspect thereof;

FIG. 16 is an enlarged cross-sectional view of a portion of a glass substrate on which filter films are formed by the manufacturing method as viewed from a side aspect thereof;

FIG. 17 is an enlarged cross-sectional view of a portion of a glass substrate on which filter films are formed by the manufacturing method as viewed from a side aspect thereof; and

FIG. 18 is an enlarged cross sectional diagram illustrating a portion of a glass substrate on which filter films were created by the manufacturing method according to an embodiment of the present invention as viewed from a side aspect thereof.

### DETAILED DESCRIPTION OF THE PREFERRED EMBODIMENTS

Referring to the accompanying drawings, exemplary embodiments according to the present invention are explained in detail below.

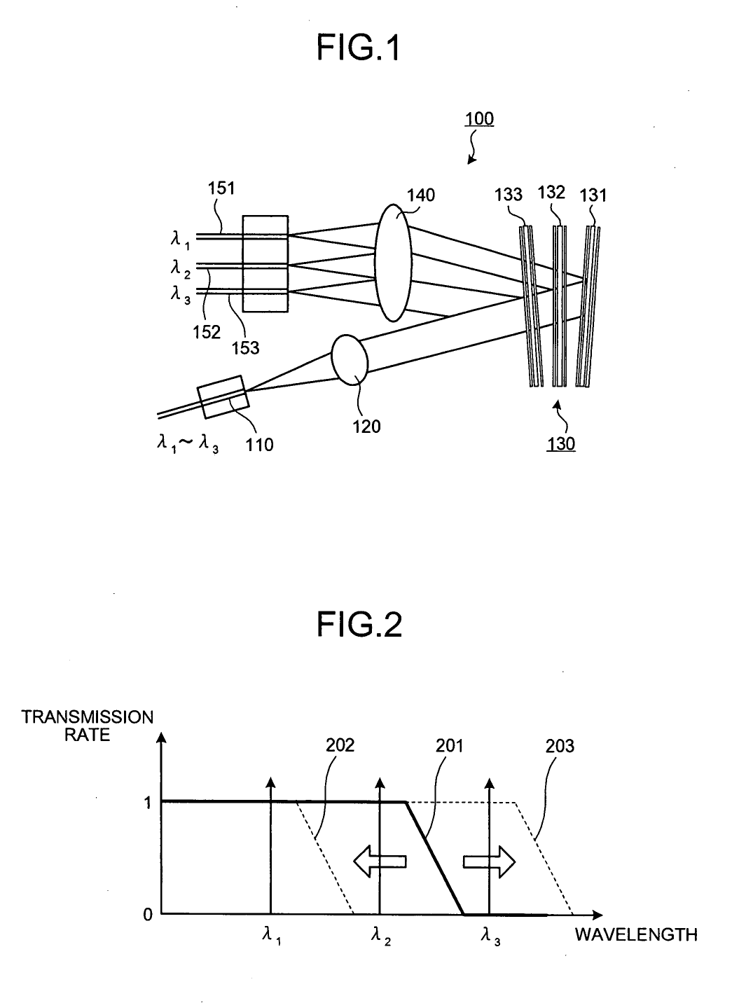

FIG. 1 is a schematic of a multiplexer-demultiplexer according to an embodiment of the present invention. As illustrated in FIG. 1, a multiplexer-demultiplexer 100 includes a multi-wavelength light port 110, a first lens 120, a multilayer filter 130, a second lens 140, and ports 151, 152, and 153.

The multi-wavelength light port 110 is a port through which a multi-wavelength light having multiple wavelengths passes in and out. The multi-wavelength light port 110 is a single core optical fiber through which the multi-wavelength light having, in this example, three wavelengths λ1, λ2, and λ3 (where, λ1<λ2<λ3) passes. The first lens 120 is positioned to collimate the multi-wavelength light from the multi-wavelength light port 110.

The multilayer filter 130 includes multiple filter films, in this example, three filter films 131, 132, and 133. The multilayer filter 130 is positioned such that the multi-wavelength light collimated by the first lens 120 enters at an angle other than a right angle. Further, the multilayer filter 130 demultiplexes the collimated multi-wavelength light according to wavelength into a plurality of single-wavelength lights, and reflects each of the single-wavelength lights at different angles.

Specifically, the filter films 131, 132, and 133 correspond to the wavelengths λ1, λ2, and λ3, respectively, and are arranged to reflect light having the corresponding wavelength and to transmit light having a wavelength other than the corresponding wavelength. The light reflected by the filter films 131, 132, and 133 are single-wavelength lights each having different wavelengths λ1, λ2, and λ3 that are obtained by demultiplexing the multi-wavelength light.

The filter films 131, 132, and 133 reflect light having wavelengths equal to or greater than the corresponding wavelength and transmit light having a wavelength less than the corresponding wavelength. In this case, the filter films 131, 132, and 133 are arranged in a descending order of wavelength, from a side on which the first lens 120 and the second lens 140 are positioned. In other words, the filter films 131, 132, and 133 are arranged in the order of the filter films 133, 132, and 131.

Further, the filter films 131, 132, and 133 are positioned at different angles from each other, and the light is reflected at a different angle by each. For example, the longer the wavelength is, the more the angle between the incoming multi-wavelength light collimated by the first lens 120 and the respective filter film 131, 132, and 133 approaches a perpendicular angle. In other words, the angle between the collimated light and the filter film becomes closer to a perpendicular angle in the order of the filter films 133, 132, and 131. Consequently, the angle of reflection is least for filter film 133, followed by the filter films 132 and 131, respectively.

The second lens 140 is positioned such that each of the single-wavelength lights reflected by the filter films 131, 132, and 133 converge at a different position.

Single-wavelength lights each having a different wavelength pass in and out of corresponding ports 151, 152, and 153. The ports 151, 152, and 153 are provided at positions at which the single-wavelength lights converge, respectively. The ports 151, 152, and 153 are a multi-core optical fiber through which single-wavelength lights of different wavelengths λ1, λ2, and λ3 pass in and out. Each optical fiber in the multi-core optical fiber corresponds to a single-wavelength light.

With this configuration, when a multi-wavelength light from the multi-wavelength light port 110 enters the first lens 120, the multi-wavelength light is demultiplexed into single-wavelength lights according to wavelength by the multilayer filter 130, and each of the single-wavelength lights passes from the second lens 140 to the respective ports 151, 152, and 153. Meanwhile, when single-wavelength lights each having a different wavelength enter the second lens 140 from the ports 151, 152, and 153, the single-wavelength lights are combined by the multilayer filter 130 into a multi-wavelength light, and the multi-wavelength light passes from the first lens 120 to the multi-wavelength light port 110.

Moreover, the filter films 131, 132, and 133 may transmit light having a wavelength greater than the corresponding wavelength and reflect light having a wavelength equal to or less than the corresponding wavelength. In this case, the filter films 131, 132, and 133 are arranged in an ascending order of the corresponding wavelength, from the side on which the first lens 120 and the second lens 140 are positioned. In other words, the filter films are arranged in the order of filter film 131, 132, and 133.

FIG. 2 is a graph illustrating transmission characteristics of filters. FIG. 2 illustrates a transmission characteristic 201 of the filter film 133 when a multi-wavelength light enters the filter film 133 at an incident angle θ. In the graph, the horizontal axis represents the wavelength of the light entering the filter film 133 and the vertical axis represents the transmission rate.

As illustrated in FIG. 2, the filter film 133 has a transmission rate of approximately 1 for light having a wavelength from 0 to λ2. Further, the transmission rate from light having wavelengths between λ₂ and λ₃ declines and the transmission rate for light having the wavelength λ₃ is 0. In other words, the filter film 133 is reflecting light having the wavelength λ3, and is transmitting light having the wavelengths λ₁ and λ₂.

In the case that the incident angle θ approaches a perpendicular angle, the transmission characteristic of the filter film 133 changes as illustrated by a reference character 202 in FIG. 2. As a result, the light having the wavelength λ₂ is reflected. On the other hand, in the case that the incident angle θ diverges from a perpendicular angle, the transmission characteristic of the filter film 133 changes as illustrated by a reference character 203 in FIG. 2. As a result, the light having the wavelength λ₃ is transmitted.

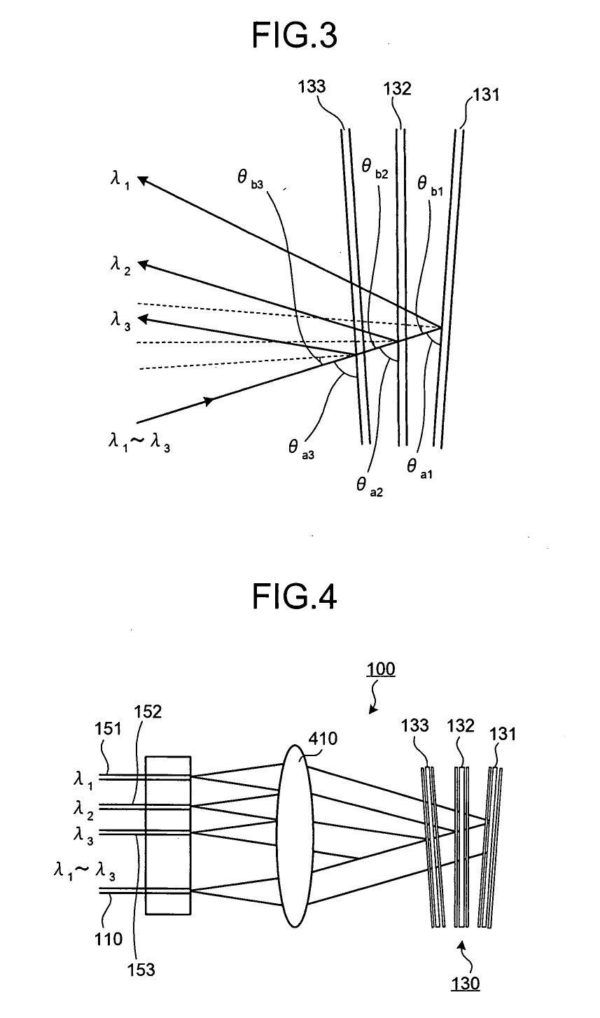

FIG. 3 is a schematic illustrating angles at which the filters reflect light. The above case in which the angle between the incoming collimated multi-wavelength light and the filter film 133 is closest to a perpendicular angle, followed by the angle with the filter films 132 and 131, respectively is described. If each of the angles between the filter films 131, 132, and 133 and the incoming collimated multi-wavelength light are set as θₐ₁, θₐ₂, and θₐ₃, then θₐ₁<θₐ₂<θₐ₃. Consequently, each of the angles at which the filter films 131, 132, and 133 reflect the incoming collimated multi-wavelength light are θ_{b1}, θ_{b2}, and θ_{b3}, respectively, where, θ_{b3}<θ_{b2}<θ_{b1}.

With such an arrangement of the filter films 131, 132, and 133 such that the angle between the incoming multi-wavelength light and the respective filter films becomes closer to a perpendicular angle in the order of the filter films 133, 132, and 131, the angle at which, for example, the light having the wavelength λ₂ that has passed through the filter film 133 and reflected on the filter film 132 and re-enters the filter film 133 becomes larger than the incident angle at which the light having the wavelength λ₂ enters the filter film 133 first, thereby avoiding a case in which the reflected light can not be transmitted again through the filter film 133.

FIG. 4 is a schematic of a multiplexer-demultiplexer according a modification of the embodiment. As illustrated in FIG. 4, the multiplexer-demultiplexer 100 may be realized by combining the functions of the first lens 120 and the second lens 140 into a single lens 410. In this case, the lens 410 transmits and either collimates or converges both the multi-wavelength light passing in and out through the multi-wavelength light port 110 and the single-wavelength lights passing in and out through the ports 151, 152, and 153.

Next, a manufacturing example of the multilayer filter 130 for the multiplexer-demultiplexer 100 according to an embodiment of the present invention is described. The multilayer filter 130 is formed by the filter films 131, 132, and 133 in an arrangement such that each has a different angle. Here, the multilayer filter 130 is manufactured by layering filter films.

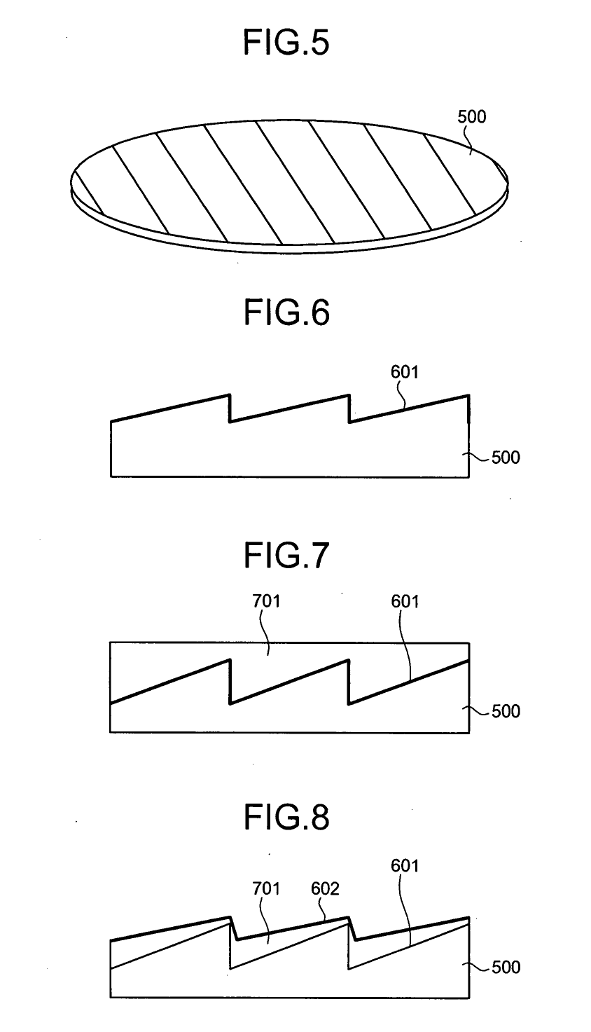

FIG. 5 is a perspective view of a glass substrate for manufacturing a multilayer filter. FIG. 6 is an enlarged cross sectional view of a portion of the glass substrate. FIG. 7 is an enlarged cross sectional view of a portion of the glass substrate coated with polyimide. FIG. 8 is an enlarged cross sectional diagram of a portion of the glass substrate coated with polyimide that has hardened and contracted. As illustrated in FIG. 5 and FIG. 6, on a surface of the glass substrate, an array of grooves shaped resembling a sawtooth is provided.

First, on the grooved surface of the glass substrate 500, a first layer filter film 601 is created. The surface of the first layer filter film 601 has the sawtooth-shape of the glass substrate 500 also. The first layer filter film 601 is, for example, made of quartz or oxidized titanium. Further, the first layer filter film 601 is created on the grooved surface of the glass substrate 500, for example, by vapor deposition.

Next, as illustrated in FIG. 7, on the grooved surface of the first layer filter film 601, a coating of a polyimide 701 diluted by a solvent is applied. For example, by a method such as spin coating, a coating of the polyimide 701 is applied such that the grooved surface of the first layer filter film 601 becomes level. The polyimide 701 has hardening and contracting properties, and when heat is applied, the polyimide 701 hardens and contracts.

Next, heat is applied to the polyimide 701 coated surface of the first layer filter film 601 to harden and contract the polyimide 701. As a result, as illustrated in FIG. 8, the surface of the hardened and contracted polyimide 701 has a different angle from the grooved surface of the glass substrate 500. Next, by creating a second layer filter film 602 on the surface of the hardened and contracted polyimide 701, the first layer filter film 601 and the second layer filter film have different angles from each other.

Further, on the surface of the second layer filter film 602, a new coating of polyimide 701 is applied, made to harden and contract, and then a new filter film is formed thereon, and by repeating these processes, the multilayer filter 130 having an arrangement of multiple filter films that each has a different angle can be manufactured. Moreover, here, an example in which polyimide 701 is applied to the surfaces of the first layer filter film 601 and the second layer filter film 602, however, the applied material is not limited to polyimide and other substrates having hardening and contracting properties can be used.

In this way, because each of the filter films 131, 132, and 133 is arranged having a different angle, the multiplexer-demultiplexer 100 according to an embodiment of the present invention reflects single-wavelength lights in different directions by the filter films 131, 132, and 133. As such, a configuration including one lens 140 is possible. Further, a configuration including the lens 120 and the lens 140 as one lens is also possible. Hence, the quantity of collimating lenses can be reduced, thereby also enabling a reduction in size.

Further, in the manufacturing method according to an embodiment of the present invention, the use of hardening and contracting properties of a material such as polyimide, enables the filter films 131, 132, and 133 to be arranged easily such that each has a different angle, and also enables multiple multilayer filters 130 to be manufactured simultaneously. As such, the multilayer filter 130 can be manufactured more easily and efficiently than, for example, manufacturing multiple prisms and then superposing the prisms on one another.

Hereinafter, an example of a multiplexer-demultiplexer, a receiver, a transmitter, and a manufacturing method for multilayer filter according to an embodiment of the present invention are described.

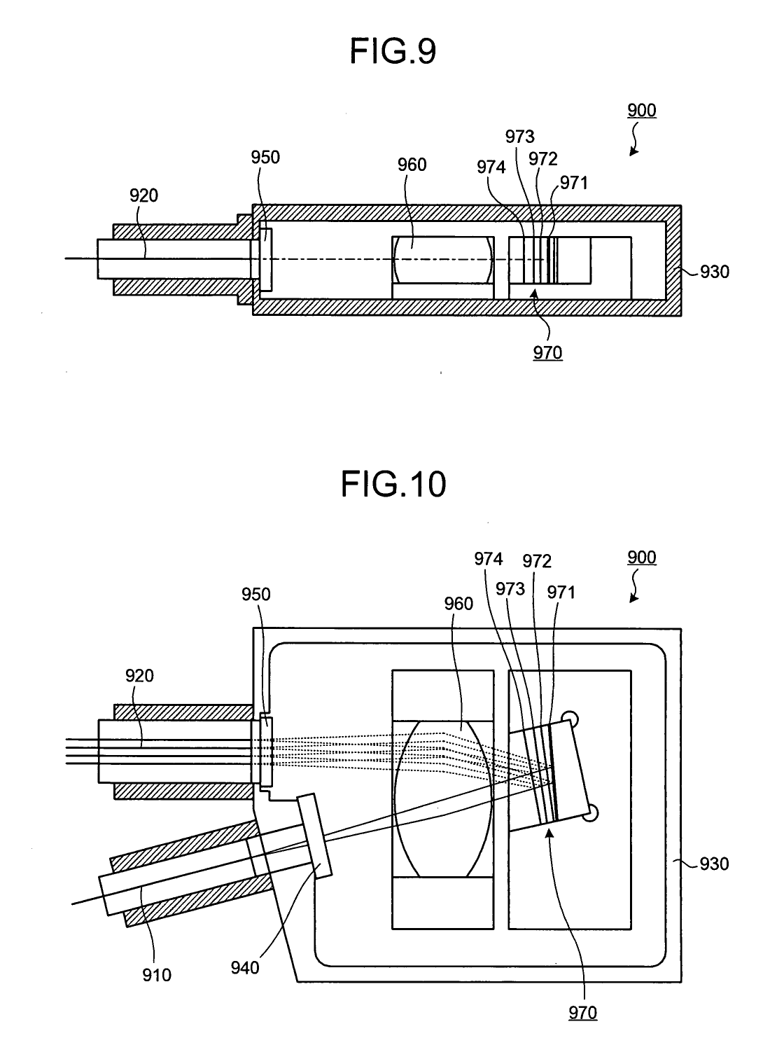

FIG. 9 is a cross sectional diagram illustrating a first example of a multiplexer-demultiplexer according an embodiment of the present invention as viewed from a front aspect of the multiplexer-demultiplexer. FIG. 10 is a plan view of the first example of the multiplexer-demultiplexer according to an embodiment of the present invention. As illustrated in FIG. 9 and FIG. 10, a multiplexer-demultiplexer 900 according an embodiment of the present invention includes a first optical fiber 910, a second optical fiber 920, and a casing 930.

The first optical fiber 910 is a single core optical fiber that transmits multi-wavelength light which includes single-wavelength lights having four types of wavelengths λ₁ to λ₄ (where, λ₁<λ₂<λ₃<λ₄). The second optical fiber 920 is a multi-core optical fiber that transmits each of the single-wavelength lights having the four types of wavelengths λ₁ to λ₄. The first optical fiber 910 and the second optical fiber 920 are each connected to the casing 930 and each respectively transmits multi-wavelength light and single-wavelength lights to and from the casing 930.

The casing 930 includes a first window 940, a second window 950, a lens 960, and a multilayer filter 970. The first window 940 is provided at a connection between the first optical fiber 910 and the casing 930, and transmits multi-wavelength light that pass between the first optical fiber 910 and the casing 930. The second window 950 is provided at a connection between the second optical fiber 920 and the casing 930, and transmits single-wavelength lights that pass between the second optical fiber 920 and the casing 930.

The lens 960, similarly to the lens 410 of the multiplexer-demultiplexer 100 according to a modification example of the present invention, transmits and either collimates or converges both multi-wavelength light passing between the first optical fiber 910 and the casing 930 and single-wavelength lights passing between the second optical fiber 920 and the casing 930.

The multilayer filter 970 includes multiple filter films 971, 972, 973, and 974 arranged such that each filter film has a different angle and according to wavelength, separates the multi-wavelength light collimated by the lens 960 that enters from the first optical fiber 910, and then reflects each single-wavelength light at a different angle. Meanwhile, the single-wavelength lights collimated by the lens 960 that enter from the second optical fiber 920 are combined and reflected.

The filters films 971, 972, 973, and 974 each corresponds to different wavelength λ₁, λ₂, λ₃, and λ₄, respectively reflect light having wavelengths equal to or greater than the corresponding wavelength and transmit light having wavelengths less than the corresponding wavelength. In this case, the filter films 971, 972, 973, and 974 are arranged from the lens 960 in descending order according to wavelength, namely, in the order of filter films 974, 973, 972, and 971.

Further, the arrangement of the filter films 971 to 974 is such that the angle at which the multi-wavelength light collimated by the lens 960 enters the filter film 974 is closest to a perpendicular angle followed by filter films 973, 972, and 971, respectively.

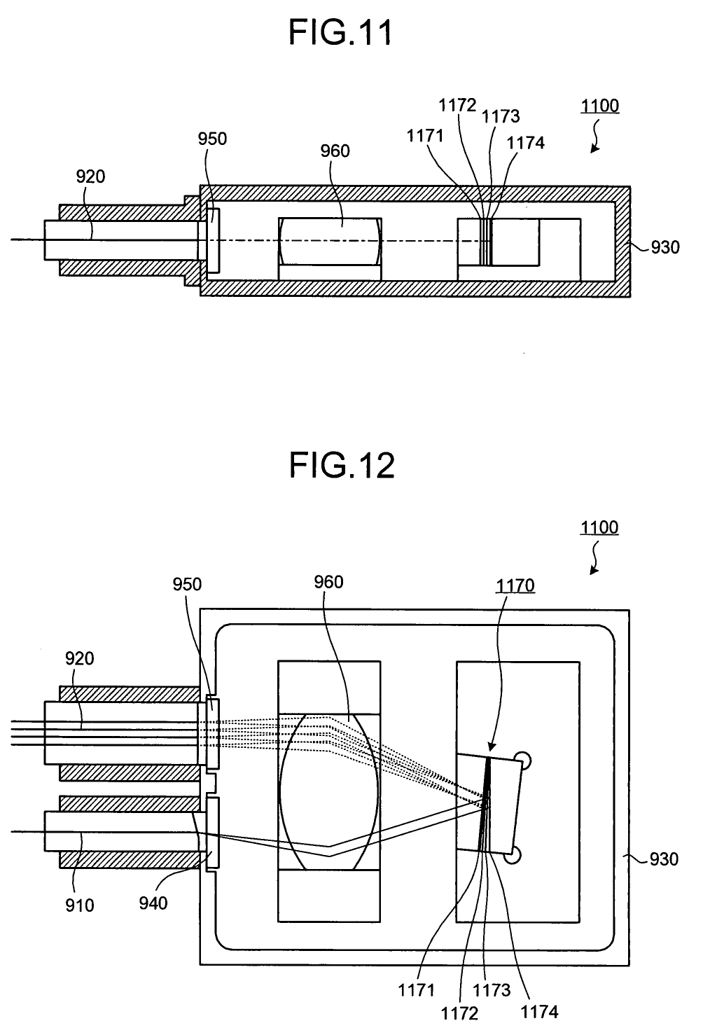

FIG. 11 is a cross sectional view illustrating a second example of a multiplexer-demultiplexer according an embodiment of the present invention as viewed from a front aspect of the multiplexer-demultiplexer. FIG. 12 is a plan view of the second example of the multiplexer-demultiplexer according to an embodiment of the present invention. A multiplexer-demultiplexer 1100 shown in FIG. 11 and FIG. 12 has a similar structure to the first example multiplexer-demultiplexer 900 and description of common elements having the same reference characters is omitted.

Filter films 1171, 1172, 1173, and 1174 included a multilayer filter 1170 of the multiplexer-demultiplexer 1100 correspond to different wavelength λ₁, λ₂, λ₃, and λ₄, respectively, and transmit light having wavelengths equal to or greater than the corresponding wavelength and reflect light having wavelengths less than the corresponding wavelength. In this case, the filter films 1171, 1172, 1173, and 1174 are arranged from the lens 960 in ascending order according to the corresponding wavelength, namely, in the order of the filter films 1171, 1172, 1173, and 1174.

Further, the filter films 1171, 1172, 1173, and 1174 are positioned such that the angle at which the multi-wavelength light collimated by the lens 960 enters each of the filter films 1171, 1172, 1173, and 1174 is closest to a perpendicular angle for the filter film 1174, followed by 1173, 1172, and 1171, respectively.

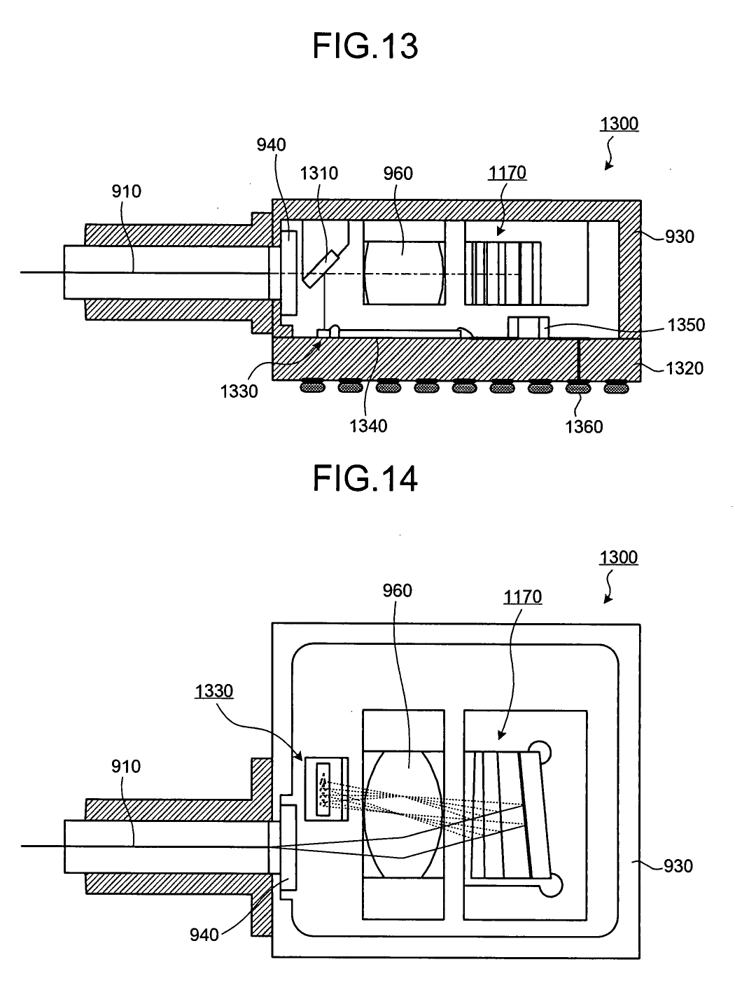

FIG. 13 is a cross sectional view illustrating a receiver according to a third example of an embodiment of the present invention as viewed from a front aspect of the receiver. FIG. 14 is a plan view of the receiver according to the third example of an embodiment of the present invention. The module illustrated in FIG. 13 and FIG. 14 has a similar structure to the multiplexer-demultiplexer 1100 of the second example and description of common elements is omitted.

According to the third example, the multiplexer-demultiplexer 100 according to the modification example of the first embodiment is used as a separating module in a receiver. As illustrated in FIG. 13 and FIG. 14, a receiver 1300 according to the third example, includes the first optical fiber 910 and the casing 930.

The first optical fiber 910 receives a multi-wavelength optical signal that includes multiple single-wavelength optical signals, each having a different wavelength, and sends the multi-wavelength optical signal to the casing 930. The casing 930 includes the first window 940, the lens 960, the multilayer filter 1170, a mirror 1310, a ceramic substrate 1320, four light receiving elements 1330, a receiving integrated circuit (IC) 1340, a chip 1350, and a soldered bump 1360.

The multi-wavelength optical signal carried by the first optical fiber 910 to the casing 930 is transmitted to the lens 960 through the first window 940 which is provided at a connection between the first optical fiber 910 and the casing 930. The lens 960 collimates the multi-wavelength optical signal, and transmits the collimated multi-wavelength optical signal to the multilayer filter 1170. Furthermore, the lens 960 collimates each of the single-wavelength optical signals from the multilayer filter 1170 and transmits the collimated single-wavelength optical signal to the four light receiving elements 1330 by the mirror 1310.

The mirror 1310 respectively reflects each of the single-wavelength optical signals transmitted from the lens 960 to the four light receiving elements 1330. On the ceramic substrate 1320, the four light receiving elements 1330, the receiving IC 1340, and the chip 1350 are arranged. The four light receiving elements 1330 receive each of the single-wavelength optical signals that were separated by the multilayer filter 1170 and convert each to an electrical signal.

The receiving IC 1340 and the chip 1350 perform various types of signal processing, such as demodulation, on each of the electrical signals converted by the four light receiving elements 1330. The soldered bump 1360 fixes the receiver 1300 on a substrate of a receiving apparatus and passes the electrical signals that were converted by the four light receiving elements 1330 and processed by the receiving IC 1340 and the chip 1350 in and out of the receiving apparatus.

This configuration enables the multi-wavelength optical signal received by the first optical fiber 910 to be separated by the multilayer filter 1170, and through the conversion of each of the single-wavelength optical signals to electrical signals by the four light receiving elements 1330, multiple signals can be received simultaneously.

Moreover, the receiver 1300, which applies the multiplexer-demultiplexer 100 as a separating module, has been described. However, similarly, any of the various mentioned multiplexer-demultiplexers 100 according to embodiments of the present invention, can be applied as a separating module in a receiver.

Further, by replacing the four light receiving elements 1330 with multiple light generating elements that emit single-wavelength optical signals having various wavelengths, a transmitting module that applies the multiplexer-demultiplexer 100 as a combining module is also possible. In the case of such a configuration, the single-wavelength optical signals emitted by the light generating elements are combined by the multilayer filter 1170 and by the transmission of the multi-wavelength optical signal through the first optical fiber 910, multiple signals can be simultaneously transmitted.

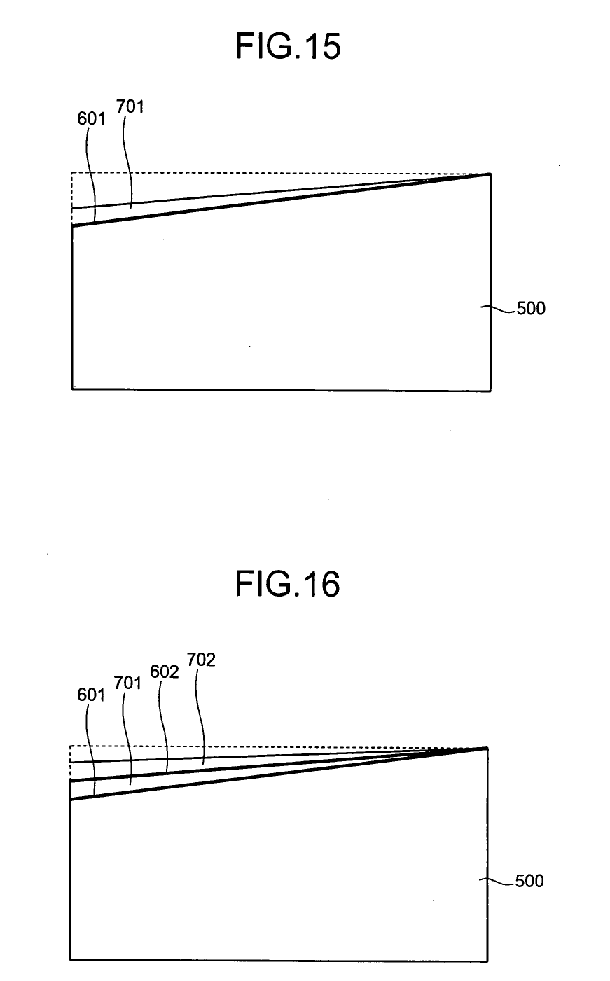

FIG. 15 to FIG. 18 are enlarged cross sectional view illustrating a portion of a glass substrate on which filter films were created by the manufacturing method according to an embodiment of the present invention as viewed from a side aspect of the glass substrate. FIG. 15 illustrates a portion of the glass substrate 500 in which the first layer filter film 601 has been created on the grooved surface of the glass substrate 500, and subsequently, on the surface of the first layer filter film 601, the polyimide 701 is applied and made to harden and contract. FIG. 16 illustrates a portion of the glass substrate 500 in which the second layer filter film 602 is created on the surface of the polyimide 701 and subsequently, on the surface of the second layer filter film 602, a polyimide 702 is applied and made to harden and contract.

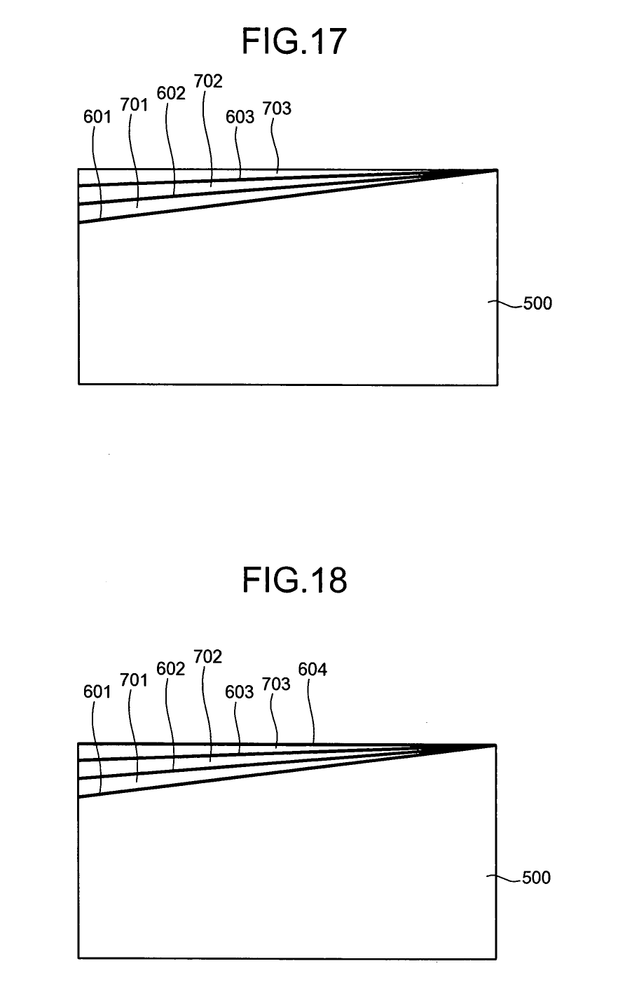

FIG. 17 illustrates a portion of the glass substrate 500 in which a third layer filter film 603 is created on the surface of the polyimide 702 and subsequently, on the surface of the third layer filter film 603, a polyimide 703 is applied and made to harden and contract. FIG. 18 illustrates a fourth layer filter film 604 created on the polyimide 703.

As illustrated in FIG. 15 to FIG. 18, in the case of manufacturing a four-layer film filter, with the progression of the manufacturing process of each of the filter films, the sawtooth-shaped grooves of the substrate surface on which the polyimide 701, 702, and 703 are applied become shallower. Hence, in order for the filter films 601, 602, 603, and 604 to be arranged such that the angle between the filter films 601, 602, 603, and 604 varies by a constant degree, at each manufacturing process step, the hardening and contracting rate of the polyimide applied should be changed.

For example, by adjusting the volume of the dilution solvent for the polyimide, the following rates can be set: for polyimide 701, the hardening and contracting rate is approximately 65%, for polyimide 702, the hardening and contracting rate is approximately 50%, and for polyimide 703, the hardening and contracting rate is approximately 5%. In this way, by making the hardening and contracting rates of the polyimide closer to the glass substrate 500 higher, the filter films 601, 602, 603, and 604 can be arranged to have a nearly constant angle relative to one another.

As described, the multiplexer-demultiplexer according to the present invention can effect reduction in the quantity of collimating lens used and in size. Further, the manufacturing method according to the present invention enables easy and efficient manufacture of the multilayer filter according to the present invention.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A multiplexer-demultiplexer comprising:
a first lens that collimates a multi-wavelength light having a plurality of different wavelengths;
a filter unit that includes a plurality of filters, that is arranged such that the collimated multi-wavelength light enters at an angle other than a right angle, and that demultiplexes the multi-wavelength light into a plurality of lights each having a different wavelength so as to reflect the lights at different angles from each other, the filters arranged so as to have different angles from each other; and
a second lens that converges each of the reflected lights to a different point corresponding to the different wavelength.

2. A multiplexer-demultiplexer comprising:
a first port through which a multi-wavelength light having a plurality of different wavelengths passes;
a first lens that collimates the multi-wavelength light from the multi-wavelength light port;
a filter unit that includes a plurality of filters, and through which the collimated multi-wavelength light enters at an angle other than a right angle, wherein the filters respectively correspond to the different wavelengths of the multi-wavelength light, each of the filters is configured to reflect a light having a wavelength corresponding thereto and to pass through a light having a wavelength other than the wavelength corresponding thereto, and the filters are arranged so as to have different angles from each other;
a second lens that converges each of the reflected lights to a different point corresponding to the different wavelength; and
a plurality of second ports that respectively correspond to the different wavelengths, and each of which is positioned at the different point so that the converged light having a wavelength corresponding thereto passes therethrough.

3. The multiplexer-demultiplexer according to claim 2, wherein the filters are arranged such that a filter corresponding to a longer wavelength among the different wavelengths has an angle closer to a right angle with respect to the multi-wavelength light.

4. The multiplexer-demultiplexer according to claim 2, wherein each of the filters reflects light having wavelength equal to or longer than the corresponding wavelength and transmits light having wavelength shorter than the corresponding wavelength, and are arranged in a descending order of the corresponding wavelength from a side on which the first lens and the second lens are located.

5. The multiplexer-demultiplexer according to claim 2, wherein each of the filters transmits light having wavelength equal to or longer than the corresponding wavelength and reflects light having wavelength shorter than the corresponding wavelength, and are arranged in an ascending order of the corresponding wavelength from a side on which the first lens and the second lens are located.

6. The multiplexer-demultiplexer according to claim 2, wherein the first lens and the second lens are constituted by a single lens.

7. A receiver comprising the multiplexer-demultiplexer according to claim 2, wherein
the ports are replaced by a plurality of light receiving elements that convert each of the single-wavelength lights output from the second lens into a plurality of electrical signals, and
the multi-wavelength light port receives the multi-wavelength light from another communication apparatus and outputs, to the first lens, the multi-wavelength light.

8. A transmitter comprising the multiplexer-demultiplexer according to claim 2, wherein
the ports are replaced by a plurality of light emitting devices that convert a plurality electrical signals into the single-wavelength lights and output the single-wavelength lights to the second lens, and
the multi-wavelength light port outputs, to another communication apparatus, the multi-wavelength light incoming from the first lens.

9. A manufacturing method for a filter having a plurality of filter films that are layered, comprising:
forming a filter on a surface of a substrate, the surface on which grooves are formed in a saw-tooth shape;
applying a material having hardening and contracting properties on a surface of the filter;
causing the material to harden and a contract; and
creating a new filter on a surface of the hardened and contracted material, wherein
steps of the applying the material on the surface of the filter, the causing the material to harden and contract, and the creating a new filter are repeated.

10. The manufacturing method according to claim 9, wherein
a hardening and contracting rate of the material is varied depending on a position of the film on the substrate, and
the closer the position is to the substrate, the higher the hardening and contracting rate becomes.
